(19) United States
(12) Patent Application Publication
(10) Pub. No.: US 2026/0085194 A1
(43) Pub. Date: Mar. 26, 2026

(54) OPTICAL PRODUCT

(71) Applicant: TOKYO OHKA KOGYO CO., LTD., Kanagawa (JP)

(72) Inventors: Hisato SHIMIZU, Kanagawa (JP); Takahiro SENZAKI, Kanagawa (JP)

(21) Appl. No.: 19/215,786

(22) Filed: May 22, 2025

(30) Foreign Application Priority Data
May 28, 2024 (JP) 2024-086126

(51) Int. Cl. C09D 5/16; C08F 220/58; C08F 220/70; C09D 4/06; C09D 7/45; C09D 125/18; C09D 133/26

(52) U.S. Cl. CPC C09D 5/1668; C08F 220/585; C08F 220/70; C09D 4/06; C09D 7/45; C09D 125/18; C09D 133/26; C08F 2800/10

(57) ABSTRACT

To provide an optical product including an anti-fog coating film having excellent anti-fog durability. An optical product including a transparent material and an anti-fog coating film disposed on a surface of the transparent material, in which the anti-fog coating film is obtained by drying and/or curing a coating film formed from an anti-fog coating composition, the anti-fog coating composition contains a polymer (A), a substrate component (B), and a surfactant (C), the polymer (A) includes a constituent unit derived from a compound (a) having an ethylenically unsaturated group and an ionic group, a constituent unit derived from a compound (b) having an ethylenically unsaturated group and an —OH group and/or an —NH₂ group, and a constituent unit derived from a compound (c) represented by the following formula (c-1), and has a structure derived from a compound (d) having a thiol group and a hydrocarbon group having 4 or more carbon atoms at least at one terminal of a main chain.

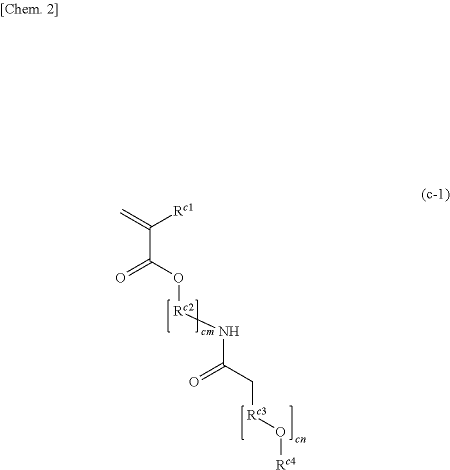

This application is based on and claims the benefit of priority from Japanese Patent Application No. 2024-086126, filed on 28 May 2024, the content of which is incorporated herein by reference.

### BACKGROUND OF THE INVENTION

### Field of the Invention

The present invention relates to an optical product including a transparent material and an anti-fog coating film disposed on a surface of the transparent material.

### Related Art

In humid places, condensation may form on surfaces of objects. In particular, for optical products with transparent materials such as mirrors, windows, prisms, or lenses, when the passage of light is hindered by fogging caused by condensation, a normal view is not provided to a user. Therefore, such an optical product preferably has a function of preventing fogging.

In order to solve the above problem, for example, Patent Document 1 proposes a curable composition containing a predetermined (meth)acrylate compound and a surfactant.
Patent Document 1: Japanese Unexamined Patent Application, Publication No. 2022-156125

### SUMMARY OF THE INVENTION

The curable composition described in Patent Document 1 provides a cured film having excellent antifogging properties, but when the cured film is in contact with water for an extended period, the antifogging properties of the cured film may decrease even after the cured film is dried, and there is a problem in anti-fog durability.

The present invention has been made in view of the above circumstance, and an object thereof is to provide an optical product including an anti-fog coating film having excellent anti-fog durability. Another object of the present invention is to provide an anti-fog coating composition for forming the anti-fog coating film, a cured product thereof, a polymer used for the anti-fog coating film and the anti-fog coating composition, and a method for producing the polymer.

As a result of extensive studies to solve the above problem, the present inventors have found that the above problem can be solved by obtaining an anti-fog coating film from a composition containing a predetermined polymer (A), a substrate component (B), and a surfactant (C), and have completed the present invention. Specifically, the present invention provides the following.

A first aspect is an optical product including: a transparent material; and an anti-fog coating film disposed on a surface of the transparent material,
the anti-fog coating film being obtained by drying and/or curing a coating film formed from an anti-fog coating composition (a dried product and/or a cured product of the coating film formed from the anti-fog coating composition), the anti-fog coating composition containing a polymer (A), a substrate component (B), and a surfactant (C),
the polymer (A) containing a constituent unit derived from a compound (a), a constituent unit derived from a compound (b), and a constituent unit derived from a compound (c),
the polymer (A) having a structure derived from a compound (d) at least at one terminal of a main chain,
the compound (a) being a compound containing an ethylenically unsaturated group and an ionic group,
the compound (b) being a compound containing an ethylenically unsaturated group and an —OH group and/or an —NH₂ group, the compound (c) being a compound represented by the following formula (c-1),
the compound (d) being a compound containing a thiol group and a hydrocarbon group having 4 or more carbon atoms,
the base material component (B) containing a resin (B1) and/or a polymerizable monomer (B2),

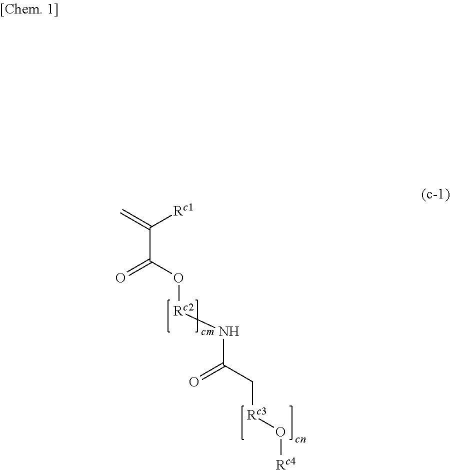

in the formula (c-1), R^{c1} represents a hydrogen atom or a methyl group, R^{c2} represents a hydrocarbon group having 1 or more and 12 or less carbon atoms, R^{c3} represents a hydrocarbon group having 2 or more and 4 or less carbon atoms, R^{c4} represents a hydrocarbon group having 12 or more carbon atoms, cm represents 0 or 1, and cn represents an integer of 1 or more and 500 or less.

A second aspect is an anti-fog coating composition containing: a polymer (A); a substrate component (B); and a surfactant (C),
the polymer (A) containing a constituent unit derived from a compound (a), a constituent unit derived from a compound (b), and a constituent unit derived from a compound (c),
the polymer (A) having a structure derived from a compound (d) at least at one terminal of a main chain,
the compound (a) being a compound containing an ethylenically unsaturated group and an ionic group,
the compound (b) being a compound containing an ethylenically unsaturated group and an —OH group and/or an —NH₂ group, the compound (c) being a compound represented by the following formula (c-1),
the compound (d) being a compound containing a thiol group and a hydrocarbon group having 4 or more carbon atoms,
the substrate component (B) comprising a resin (B1) and/or a polymerizable monomer (B2),

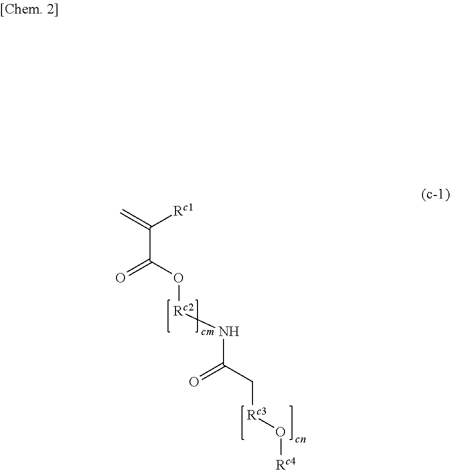

in the formula (c-1), R^{c1} represents a hydrogen atom or a methyl group, R^{c2} represents a hydrocarbon group having 1 or more and 12 or less carbon atoms, R^{c3} represents a hydrocarbon group having 2 or more and 4 or less carbon atoms, R^{c4} represents a hydrocarbon group having 12 or more carbon atoms, cm represents 0 or 1, and cn represents an integer of 1 or more and 500 or less.

A third aspect is a cured product of the anti-fog coating composition as described in the second aspect.

A fourth aspect is an anti-fog coating film obtained by drying and/or curing a coating film formed from the anti-fog coating composition as described in the second aspect (a dried product and/or a cured product of the coating film formed from the anti-fog coating composition as described in the second aspect).

A fifth aspect is a polymer containing: a constituent unit derived from a compound (a); a constituent unit derived from a compound (b); and a constituent unit derived from a compound (c),
the polymer having a structure derived from a compound (d) at least at one terminal of a main chain,
the compound (a) being a compound containing an ethylenically unsaturated group and an ionic group,
the compound (b) being a compound containing an ethylenically unsaturated group and an —OH group and/or an —NH₂ group, the compound (c) being a compound represented by the following formula (c-1),
the compound (d) being a compound containing a thiol group and a hydrocarbon group having 4 or more carbon atoms,

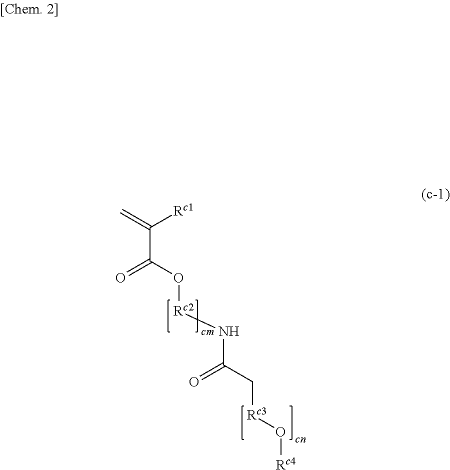

in the formula (c-1), R^{c1} represents a hydrogen atom or a methyl group, R^{c2} represents a hydrocarbon group having 1 or more and 12 or less carbon atoms, R^{c3} represents a hydrocarbon group having 2 or more and 4 or less carbon atoms, R^{c4} represents a hydrocarbon group having 12 or more carbon atoms, cm represents 0 or 1, and cn represents an integer of 1 or more and 500 or less.

A sixth aspect is a method for producing the polymer as described in the fifth aspect, the method including: polymerizing the compound (a), the compound (b), and the compound (c) in the presence of the compound (d).

According to the present invention, it is possible to provide an optical product including an anti-fog coating film having excellent anti-fog durability. It is also possible to provide an anti-fog coating composition for forming the anti-fog coating film, a cured product thereof, a polymer used for the anti-fog coating film and the anti-fog coating composition, and a method for producing the polymer.

### DETAILED DESCRIPTION OF THE INVENTION

Although embodiments of the present invention will be described below in detail, the present invention is not limited to the embodiments below in any way and can be implemented with modifications as appropriate within the scope of the object of the present invention.

### «Optical Product»

An optical product includes a transparent material and an anti-fog coating film disposed on a surface of the transparent material. The anti-fog coating film is obtained by drying and/or curing a coating film formed from an anti-fog coating composition (a dried product and/or a cured product of the coating film formed from the anti-fog coating composition). The anti-fog coating composition includes a polymer (A), a substrate component (B), and a surfactant (C). The polymer (A) includes a constituent unit derived from a compound (a) (hereinafter, also referred to as a constituent unit (a)), a constituent unit derived from a compound (b) (hereinafter, also referred to as a constituent unit (b)), and a constituent unit derived from a compound (c) (hereinafter, also referred to as a constituent unit (c)), and has a structure derived from a compound (d) (hereinafter, also referred to as a structure (d)) at least at one terminal of a main chain. The substrate component (B) contains a resin (B1) and/or a polymerizable monomer (B2).

The anti-fog coating film of the optical product has excellent anti-fog durability. An exact reason for this effect is not entirely clear, but it is presumed to be as follows. In the cured film described in Patent Document 1, a surfactant dissolved in the absorbed moisture is eluted onto a surface of the cured film to form a water film with a low surface tension, thereby exhibiting antifogging properties. It is considered that the reason why the antifogging properties of the cured film decrease is that the surfactant is excessively eluted due to prolonged contact with water and the surfactant in the cured film is originally insufficient even after the cured film is dried. It is considered that the polymer (A) is oriented on a surface of the anti-fog coating film by having both the hydrophilic constituent unit (a) and the hydrophilic constituent unit (b) and the hydrophobic constituent unit (c) and the hydrophobic structure (d). Further, it is considered that functional groups of the constituent unit (a) and the constituent unit (b) interact with the surfactant (hydrogen bonding or the like), and thus excessive elution of the surfactant can be suppressed. Furthermore, since the hydrophilic functional groups of the constituent unit (a) and the constituent unit (b) are oriented to the surface of the anti-fog coating film, hydrophilicity of the surface of the anti-fog coating film can be improved, and the anti-fog properties can be maintained regardless of the elution of the surfactant.

Hereinafter, first, the anti-fog coating composition used for obtaining the anti-fog coating film will be described.

### <Anti-Fog Coating Composition>

The anti-fog coating composition includes the polymer (A), the substrate component (B), and the surfactant (C).

### [Polymer (A)]

The polymer (A) includes the constituent unit (a) derived from the compound (a), the constituent unit (b) derived from the compound (b), and the constituent unit (c) derived from the compound (c), and has the structure (d) derived from the compound (d) at least at one terminal of the main chain.

### (Compound (a))

The compound (a) is a compound containing an ethylenically unsaturated group and an ionic group. The ionic group may be a group composed of an anion and/or a cation, or may be a group capable of forming a salt by a reaction with an electrolyte. The electrolyte is typically an acid or a base according to the Brønsted definition. It is considered that excessive elution of the surfactant is suppressed by the interaction (hydrogen bonding or the like) between the ionic group and the surfactant. In addition, it is considered that the ionic group can improve the hydrophilicity of the surface of the anti-fog coating film.

The ethylenically unsaturated group is a group containing an ethylenically unsaturated double bond. The ethylenically unsaturated group is not particularly limited, and examples thereof include alkenyl groups such as a vinyl group, a 1-propenyl group, a 2-n-propenyl group (allyl group), a 1-n-butenyl group, a 2-n-butenyl group, and a 3-n-butenyl group, and (meth)acryloyl group-containing groups such as a (meth)acryloyl group, a (meth)acryloyloxy group, and a (meth)acryloylamino group. Among these, a vinyl group, a (meth)acryloyl group, a (meth)acryloyloxy group, or a (meth)acryloylamino group is preferable.

Examples of the ionic group include a phosphonic acid group, a phosphinic acid group, a phosphoric acid group, a sulfonic acid group, salts thereof, a quaternary ammonium salt group, and a nitrogen-containing heterocyclic group. Among these, a quaternary ammonium salt group, a sulfonic acid group, or a sulfonic acid salt group is preferable. When the ionic group is a salt of an acidic group such as the sulfonic acid group, the cation constituting the salt of the acidic group may be an organic cation or an inorganic cation. The cation is preferably an inorganic cation, more preferably a metal ion, and still more preferably an alkali metal ion. Examples of the alkali metal ion include a lithium ion, a sodium ion, a potassium ion, and a strontium ion, and a sodium ion and a potassium ion are preferable. Examples of the quaternary ammonium group include a trialkylammonium salt group. The trialkylammonium salt group is represented by —N⁺(R^{a01})₃·X⁻. R^{a01} represents an alkyl group. The three R^{a01}s may be the same or different. X⁻ is a counter anion for an ammonium cation. The number of carbon atoms of the alkyl group in the trialkylammonium salt group is preferably 1 or more and 10 or less, more preferably 1 or more and 5 or less, and still more preferably 1 or more and 3 or less. Examples of the alkyl group in the trialkylammonium salt group include a methyl group, an ethyl group, an n-propyl group, and an isopropyl group. Among these, a methyl group is preferable. The counter anion in the trialkylammonium salt group is not particularly limited as long as desired effects are not impaired. The counter anion may be an organic anion or an inorganic anion. The counter anion is preferably a halide ion. Examples of the halide ion include F⁻, Cl⁻, Br⁻ and I⁻.

The compound (a) is preferably a compound represented by the following formula (a1-1):

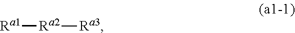

in the formula (a1-1), R^{a1} is a vinyl group, a (meth)acryloyl group, a (meth)acryloyloxy group, or a (meth)acryloylamino group, R^{a2} is a divalent hydrocarbon group having 1 or more and 10 or less carbon atoms, and R^{a3} is a quaternary ammonium salt group, a sulfonic acid group, or a sulfonate salt group.

As R^{a1}, a vinyl group, a (meth)acryloyloxy group, and a (meth)acryloylamino group are preferable, and a vinyl group and a (meth)acryloylamino group are more preferable.

The number of carbon atoms of the hydrocarbon group as R^{a2} is preferably 2 or more and 8 or less. Examples of the hydrocarbon group as R^{a2} include an alkylene group, an aromatic hydrocarbon group, and a combination of the alkylene group and the aromatic hydrocarbon group. The alkylene group may be linear or branched. The number of carbon atoms of the alkylene group is preferably 1 or more and 8 or less, and more preferably 2 or more and 5 or less. Examples of the aromatic hydrocarbon group include a phenylene group and a naphthalenediyl group, and a phenylene group is preferable.

The quaternary ammonium group as R^{a3} is the same as the quaternary ammonium group as the ionic group.

Suitable specific examples of the compound represented by the formula (a1-1) include:
((meth)acryloylaminoalkyl)trialkylammonium salts such as (3-(meth)acryloylaminopropyl)trimethylammonium chloride, (3-(meth)acryloylaminopropyl)trimethylammonium bromide, and (3- and (meth)acryloylaminopropyl)trimethylammonium iodide;
((meth)acryloyloxyalkyl)trialkylammonium salts such as (2-(meth)acryloyloxyethyl)trimethylammonium chloride, (2-(meth)acryloyloxyethyl)trimethylammonium bromide, and (2-(meth)acryloyloxyethyl)trimethylammonium iodide;
allyltrialkylammonium salts such as allyltrimethylammonium chloride, allyltrimethylammonium bromide, allyltrimethylammonium iodide, allyltriethylammonium chloride, allyltriethylammonium bromide, and allyltriethylammonium iodide;
(meth)acryloylamino alkylsulfonic acids such as 2-(meth)acryloylamino-2-methylpropanesulfonic acid, sodium 2-(meth)acryloylamino-2-methylpropanesulfonate, and potassium 2-(meth)acryloylamino-2-methylpropanesulfonate, and salts thereof; and
vinylarylsulfonic acids such as p-styrenesulfonic acid, sodium p-styrenesulfonate, potassium p-styrenesulfonate, m-styrenesulfonic acid, sodium m-styrenesulfonate, and sodium m-styrenesulfonate, and salts thereof.

### (Compound (b))

The compound (b) is a compound containing an ethylenically unsaturated group and an —OH group and/or an —NH₂ group. It is considered that excessive elution of the surfactant is suppressed by the interaction (hydrogen bonding or the like) between the —OH group or the —NH₂ group and the surfactant. In addition, it is considered that the —OH group or the —NH₂ group can improve the hydrophilicity of the surface of the anti-fog coating film. It is considered that a molecular weight of the polymer increases and elution of the polymer itself can be suppressed by providing the constituent unit (b).

The ethylenically unsaturated group in the compound (b) is the same as the ethylenically unsaturated group in the compound (a). As the ethylenically unsaturated group in the compound (b), a (meth)acryloyl group is preferable.

The compound (b) is preferably a compound represented by the following formula (b1-1):

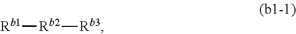

in the formula (b 1-1), R^{b1} is a (meth)acryloyl group, R^{b2} is a single bond or a divalent hydrocarbon group having 1 or more and 10 or less carbon atoms, and R^{b3} is an —OH group or an —NH₂ group.

R^{b2} is preferably a single bond. The hydrocarbon group having 1 or more and 10 or less carbon atoms as R^{b2} is the same as the hydrocarbon group having 1 or more and 10 or less carbon atoms as R^{a2}. R^{b3} is preferably an —OH group.

As the compound (b) described above, (meth)acrylamide and (meth)acrylic acid are preferable, and (meth)acrylic acid is more preferable.

### (Compound (c))

The compound (c) is a compound represented by the following formula (c-1). It is considered that the polymer (A) is oriented on the surface of the anti-fog coating film by having the hydrophobic constituent unit (c) in addition to the hydrophilic constituent unit (a) and the hydrophilic constituent unit (b).

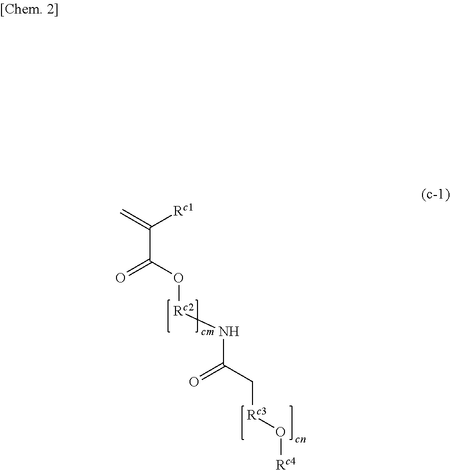

In the formula (c-1), R^{c1} represents a hydrogen atom or a methyl group, R^{c2} represents a divalent hydrocarbon group having 1 or more and 12 or less carbon atoms, R^{c3} represents a divalent hydrocarbon group having 2 or more and 4 or less carbon atoms, R^{c4} represents a monovalent hydrocarbon group having 12 or more carbon atoms, cm represents 0 or 1, and cn represents an integer of 1 or more and 500 or less.

The number of carbon atoms of the hydrocarbon group as R^{c2} is preferably 1 or more and 8 or less, and more preferably 1 or more and 5 or less. Examples of the hydrocarbon group as R^{c2} include an alkylene group and an aromatic hydrocarbon group. Among these, an alkylene group is preferable. The alkylene group may be linear or branched, but is preferably linear. The alkylene group is preferably a methylene group, an ethylene group, or a propane-1,3-diyl group, and more preferably an ethylene group.

The hydrocarbon group as R^{c3} is preferably an alkylene group, and more preferably an ethylene group.

The number of carbon atoms of the hydrocarbon group as R^{c4} is preferably 12 or more and 40 or less, more preferably 12 or more and 30 or less, still more preferably 12 or more and 25 or less, and particularly preferably 15 or more and 20 or less. Examples of the hydrocarbon group as R^{c4} include an aliphatic hydrocarbon group, an aromatic hydrocarbon group, and a combination of the aliphatic hydrocarbon group and the aromatic hydrocarbon group. As the hydrocarbon group, an aliphatic hydrocarbon group is preferable. The aliphatic hydrocarbon group may be a chain aliphatic hydrocarbon group, an alicyclic hydrocarbon group, or a combination of a chain aliphatic hydrocarbon group and an alicyclic hydrocarbon group. The aliphatic hydrocarbon group may be saturated or unsaturated, but is preferably unsaturated. The number of unsaturated bonds in the unsaturated aliphatic hydrocarbon group is preferably 1 or more and 3 or less, and more preferably 1. The position of the unsaturated bond in the unsaturated aliphatic hydrocarbon group is not particularly limited. Further, the aliphatic hydrocarbon group may be linear or branched, but is preferably linear.

Examples of the saturated aliphatic hydrocarbon group include alkyl groups such as dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, and triacontyl.

Examples of the unsaturated aliphatic hydrocarbon group include alkenyl groups such as dodecenyl, tridecenyl, tetradecenyl, pentadecenyl, hexadecenyl, heptadecenyl, octadecenyl, nonadecenyl, icosenyl, henicosenyl, docosenyl, tricosenyl, tetracosenyl, pentacosenyl, hexacosenyl, heptacosenyl, octacosenyl, nonacosenyl, and triacontenyl, and alkynyl groups such as decynyl, undecynyl, dodecynyl, tridecynyl, tetradecynyl, pentadecynyl, hexadecynyl, heptadecynyl, octadecynyl, nonadecynyl, icosynyl, henicosynyl, docosynyl, tricosynyl, tetracosynyl, pentacosynyl, hexacosynyl, heptacosynyl, octacosynyl, nonacosynyl, and triacontynyl. The number of carbon atoms of the alkenyl group and the number of carbon atoms of the alkynyl group are each preferably 12 or more and 40 or less, more preferably 12 or more and 30 or less, still more preferably 12 or more and 25 or less, and particularly preferably 15 or more and 20 or less. The alkenyl group and the alkynyl group are preferably linear.

The aliphatic hydrocarbon group is preferably an alkyl group or an alkenyl group, more preferably an alkenyl group, still more preferably a linear alkenyl group, and most preferably an octadecenyl group.

As the unsaturated aliphatic hydrocarbon group, a group represented by the following formula (c-1a) is preferable.

—R^{c41}—CH═CH—R^{c42} (c-1a)

In the formula (c-1a), R^{c41} is an alkylene group, R^{c42} is an alkyl group, and a sum of the number of carbon atoms of the alkylene group as R^{c41} and the number of carbon atoms of the alkyl group as R^{c42} is 10 or more. The number of carbon atoms of the alkylene group as R^{c41} is preferably 1 or more and 20 or less, more preferably 4 or more and 15 or less, and still more preferably 6 or more and 10 or less. The alkylene group as R^{c41} may be linear or branched, but is preferably linear. Examples of the alkylene group as R^{c41} include a methylene group, an ethane-1,2-diyl group (ethylene group), an ethane-1,1-diyl group, a propane-1,3-diyl group, a propane-1,2-diyl group, a propane-1,1-diyl group, a propane-2,2-diyl group, a butane-1,4-diyl group, a pentane-1,5-diyl group, a hexane-1,6-diyl group, a heptane-1,7-diyl group, an octane-1,8-diyl group, a nonane-1,9-diyl group, a decane-1,10-diyl group, an undecane-1,11-diyl group, a dodecane-1,12-diyl group, a tridecane-1,13-diyl group, a tetradecane-1,14-diyl group, a pentadecane-1,15-diyl group, a hexadecane-1,16-diyl group, a heptadecane-1,17-diyl group, an octadecane-1,18-diyl group, a nonadecane-1,19-diyl group, and an icosane-1,20-diyl group. The number of carbon atoms of the alkyl group as R^{c42} is preferably 1 or more and 20 or less, more preferably 4 or more and 15 or less, and still more preferably 6 or more and 10 or less. The alkyl group as R^{c42} may be linear or branched, but is preferably linear. Examples of the alkyl group as R^{c42} include a methyl group, an ethyl group, an n-propyl group, an isopropyl group, an n-butyl group, a sec-butyl group, an isobutyl group, a tert-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, and an n-icosyl group. A sum of the number of carbon atoms of the alkylene group as R^{c41} and the number of carbon atoms of the alkyl group as R^{c42} is preferably 10 or more and 38 or less, more preferably 10 or more and 28 or less, still more preferably 10 or more and 23 or less, and particularly preferably 13 or more and 18 or less.

cm is preferably 1. cn is preferably 5 or more and 300 or less, more preferably 5 or more and 100 or less, still more preferably 5 or more and 50 or less, and particularly preferably 5 or more and 30 or less.

The method for producing the compound represented by the formula (c-1) is not particularly limited. For example, the compound represented by the formula (c-1) can be obtained by reacting an isocyanate group of the compound represented by the following formula (c-1a) with a hydroxy group of the compound represented by the following formula (c-1b).

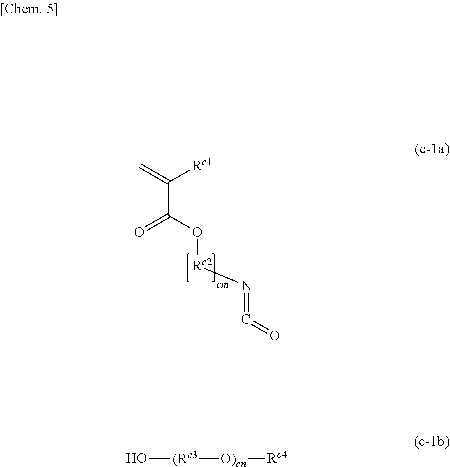

In the formula (c-1a) and the formula (c-1b), R^{c1} to R^{c4}, cm, and cn are the same as R^{c1} to R^{c4}, cm, and cn in the formula (c-1).

A molar ratio of the constituent unit (a) to all the constituent units of the polymer (A) is preferably 50 mol % or more and 98 mol % or less, more preferably 60 mol % or more and 95 mol % or less, and still more preferably 70 mol % or more and 92 mol % or less. A molar ratio of the constituent unit (b) to all the constituent units of the polymer (A) is preferably 1 mol % or more and 40 mol % or less, more preferably 2 mol % or more and 30 mol % or less, and still more preferably 3 mol % or more and 25 mol % or less. A molar ratio of the constituent unit (c) to all the constituent units of the polymer (A) is preferably 1 mol % or more and 20 mol % or less, more preferably 1 mol % or more and 12 mol % or less, and still more preferably 2 mol % or more and 6 mol % or less.

### (Compound (d))

The compound (d) is a compound containing a thiol group and a hydrocarbon group having 4 or more carbon atoms. The compound (d) acts as a chain transfer agent during polymerization of the polymer (A) and modifies a terminal end of the polymer (A). It is considered that the polymer (A) is oriented on the surface of the anti-fog coating film by having the hydrophobic structure (d) in addition to the constituent unit (a) and the constituent unit (b).

The number of carbon atoms of the hydrocarbon group is preferably 4 or more and 30 or less, more preferably 6 or more and 20 or less, and still more preferably 8 or more and 16 or less. Examples of the hydrocarbon group include an aliphatic hydrocarbon group, an aromatic hydrocarbon group, and a combination of the aliphatic hydrocarbon group and the aromatic hydrocarbon group. As the hydrocarbon group, an aliphatic hydrocarbon group is preferable. The aliphatic hydrocarbon group may be a chain aliphatic hydrocarbon group, an alicyclic hydrocarbon group, or a combination of a chain aliphatic hydrocarbon group and an alicyclic hydrocarbon group. The aliphatic hydrocarbon group may be saturated or unsaturated, but is preferably saturated. Further, the aliphatic hydrocarbon group may be linear or branched, but is preferably linear. As the aliphatic hydrocarbon group, an alkyl group is preferable, and a linear alkyl group is more preferable.

The compound (d) is preferably a compound represented by the following formula (d1-1).

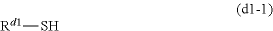

In the formula (d1-1), R^{d1} represents a monovalent hydrocarbon group having 4 or more carbon atoms.

The hydrocarbon group having 4 or more carbon atoms as R^{d1} is the same as the hydrocarbon group having 4 or more carbon atoms of the compound (d).

The structure (d) is preferably a structure represented by the following formula (d1-2).

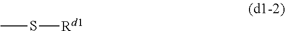

In the formula (d1-2), R^{d1} is the same as R^{d1} in the formula (d1-1).

A weight average molecular weight of the polymer (A) is preferably from 50,000 to 2,000,000, and more preferably from 70,000 to 1,200,000. In the present description, the weight average molecular weight of the polymer (A) means a weight average molecular weight in terms of standard polystyrene obtained by gel permeation chromatography (GPC) measurement.

A content of the polymer (A) per 100 parts by mass of the substrate component (B) is preferably 0.05 parts by mass or more and 10 parts by mass or less, more preferably 0.1 parts by mass or more and 5 parts by mass or less, and still more preferably 0.5 parts by mass or more and 3 parts by mass or less. Within the above numerical range, excellent antifogging properties and anti-fog durability are easily obtained.

The method for producing the polymer (A) is not particularly limited. For example, the polymer (A) can be obtained by polymerizing the compound (a), the compound (b), and the compound (c) in the presence of the compound (d) as a chain transfer agent. The polymerization can be performed by a conventionally known method using an appropriate polymerization initiator, a solvent, and the like.

### [Base Material Component (B)]

The substrate component (B) contains a resin (B1) and/or a polymerizable monomer (B2). The substrate component (B) is preferably a polymerizable monomer (B2).

### (Resin (B1))

The resin (B1) is not particularly limited as long as a material is a non-curable resin material that imparts formability such as a film forming property to the anti-fog coating composition. Specific examples of such a resin include a polyacetal resin, a polyamide resin, a polycarbonate resin, a polyester resin (polybutylene terephthalate, polyethylene terephthalate, polyarylate, or the like), a FR-AS resin, a FR-ABS resin, an AS resin, an ABS resin, a polyphenylene oxide resin, a polyphenylene sulfide resin, a polysulfone resin, a polyethersulfone resin, a polyether ether ketone resin, a fluorine-based resin, a polyimide resin, a polyamideimide resin, a polyamide bismaleimide resin, a polyetherimide resin, a polybenzoxazole resin, a polybenzothiazole resin, a polybenzimidazole resin, a silicone resin, a BT resin, polymethylpentene, ultra-high molecular weight polyethylene, FR-polypropylene, a (meth)acrylic resin (polymethyl methacrylate or the like), and polystyrene. Two or more of these resin materials may be used in combination.

### (Polymerizable Monomer (B2))

The polymerizable monomer (B2) is a compound that is cured by application of energy generated by heating, exposure, or the like, an action of a curing agent, an initiator (D) to be described later, or the like. Examples of the polymerizable monomer (B2) include a compound having an ethylenically unsaturated group such as a (meth)acrylic monomer, and a cationically polymerizable compound such as an epoxy compound, an oxetane compound, and a vinyl ether compound. The polymerizable monomer (B2) is preferably a compound having an ethylenically unsaturated group as a polymerizable group from the viewpoint of the stability of the anti-fog coating composition over time. The compound having an ethylenically unsaturated group is preferably a compound having a (meth)acryloyl group such as a (meth)acrylate compound and a (meth)acrylamide compound, and more preferably a (meth)acrylate compound. The polymerizable monomer (B2) may be a monofunctional polymerizable monomer or a polyfunctional polymerizable monomer. The polymerizable monomer (B2) preferably contains a polyfunctional polymerizable monomer in terms of the strength of the cured product, polymerization reactivity, and the like.

The polymerizable monomer (B2) is preferably a (meth)acrylate compound (B2-1) having an HLB value of 15.2 or more. Accordingly, the obtained anti-fog coating film tends to exhibit antifogging properties by absorbing moisture at the same time as the moisture adheres to a film surface.

The HLB value of the (meth)acrylate compound (B2-1) is preferably 15.5 or more, and more preferably 16.0 or more. An upper limit of the HLB value is not particularly limited, and is, for example, 19.0 or less or 18.0 or less.

In the present description, the HLB value of the (meth)acrylate compound (B2-1) is a value obtained by the following formula based on the Griffin method.

$$HLB value = 20 \times total formula weight of hydrophilic functional group / molecular weight$$

In the present description, the hydrophilic functional group is a sulfone group (—SO₃⁻), a phosphono group (—PO₃⁻), a carboxy group (—COOH), an amide group (—CONH—), an imide group (—CON—), an aldehyde group (—CHO), a hydroxy group (—OH), an amino group (—NH₂), an acetyl group (—COCH₃), an ethyleneamine group (—CH₂CH₂NH—), an ethyleneoxy group (—CH₂CH₂O—), an alkali metal ion, an alkaline earth metal ion, an ammonium ion, a halide ion, an acetate ion, or the like.

Examples of the (meth)acrylate compound (B2-1) include a polyfunctional (meth)acrylate compound having an alkyleneoxy group having 2 or more and 4 or less carbon atoms, specifically, a polyfunctional (meth)acrylate compound having an ethyleneoxy group.

The (meth)acrylate compound (B2-1) is preferably a polyfunctional (meth)acrylate compound represented by the following formula (b2-1a) and/or a bifunctional (meth)acrylate compound represented by the following formula (b2-1b), and more preferably a polyfunctional (meth)acrylate compound represented by the following formula (b2-1a).

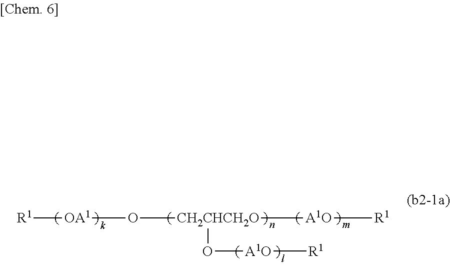

In the formula (b2-1a), n is an integer of 4 or more. Each A¹ independently represents an alkylene group having 2 or more and 4 or less carbon atoms. k, l, and m are each independently an integer of 0 or more, and a sum thereof is an integer of 50 or more. Each R¹ independently represents a hydrogen atom or a (meth)acryloyl group, and at least three R's are (meth)acryloyl groups.

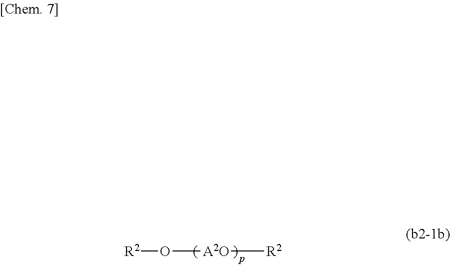

In the formula (b2-1b), A² represents an alkylene group having 2 or more and 4 or less carbon atoms. p represents an integer of 10 or more. Each R² independently represents a (meth)acryloyl group.

In the formula (b2-1a), n is preferably 4 or more and 10 or less, and more preferably 4 or more and 6 or less. The alkylene group in A¹ may be linear or branched. A¹ is preferably an ethylene group. k, 1, and m are preferably 1 or more and 40 or less, and more preferably 1 or more and 30 or less. A sum of k, 1, and m is preferably 50 or more and 100 or less, and more preferably 55 or more and 80 or less. At least four R's are preferably (meth)acryloyl groups, and at least six R's are more preferably (meth)acryloyl groups.

In the formula (b2-1b), the alkylene group in A² may be linear or branched. A² is preferably an ethylene group. p is preferably 10 or more and 30 or less, and more preferably 12 or more and 20 or less.

A content of the (meth)acrylate compound (B2-1) per 100 mass % of the substrate component (B) is preferably 35 mass % or more and 99 mass % or less, more preferably 40 mass % or more and 90 mass % or less, and still more preferably 50 mass % or more and 80 mass % or less. Within the above numerical range, good antifogging properties and anti-fog durability are easily obtained.

The polymerizable monomer (B2) preferably contains a polyfunctional (meth)acrylate compound (B2-2) other than the (meth)acrylate compound (B2-1). Accordingly, it is easy to improve curability of the anti-fog coating film.

Examples of the polyfunctional (meth)acrylate compound (B2-2) include ethylene glycol di(meth)acrylate, diethylene glycol di(meth)acrylate, tetraethylene glycol di(meth)acrylate, propylene glycol di(meth)acrylate, polypropylene glycol di(meth)acrylate, butylene glycol di(meth)acrylate, neopentyl glycol di(meth)acrylate, 1,6-hexane glycol di(meth)acrylate, trimethylolpropane tri(meth)acrylate, glycerin di(meth)acrylate, pentaerythritol tri(meth)acrylate, pentaerythritol tetra(meth)acrylate, dipentaerythritol penta(meth)acrylate, dipentaerythritol hexa(meth)acrylate, pentaerythritol di(meth)acrylate, pentaerythritol tri(meth)acrylate, pentaerythritol tetra(meth)acrylate, dipentaerythritol penta(meth)acrylate, dipentaerythritol hexa(meth)acrylate, ethylene glycol diglycidyl ether di(meth)acrylate, diethylene glycol diglycidyl ether di(meth)acrylate, phthalic acid diglycidyl ester di(meth)acrylate, glycerin tri(meth)acrylate, glycerin polyglycidyl ether poly(meth)acrylate, and the like.

A content of the polyfunctional (meth)acrylate compound (B2-2) per 100 mass % of the substrate component (B) is preferably 1 mass % or more and 65 mass % or less, more preferably 10 mass % or more and 60 mass % or less, and still more preferably 20 mass % or more and 50 mass % or less. Within the above numerical range, it is easy to achieve both an improvement in hardness and antifogging properties of the anti-fog coating film.

A content of the substrate component (B) is preferably 40 mass % or more, more preferably 60 mass % or more, and still more preferably 80 mass % or more with respect to 100 mass % (total solid content) of the anti-fog coating composition excluding the mass of the solvent (E) to be described later. The content is preferably 99 mass % or less. Within the above numerical range, good antifogging properties and anti-fog durability are easily obtained.

### [Surfactant (C)]

The anti-fog coating composition contains the surfactant (C). Accordingly, the surfactant (C) dissolved in the absorbed moisture is eluted onto the surface of the anti-fog coating film, and a water film with a low surface tension can be formed.

The surfactant (C) is preferably a water-soluble surfactant. The water-soluble surfactant is not particularly limited, but preferably exhibits solubility of 0.01 mass % or more in water at room temperature. As the surfactant (C), any of a nonionic surfactant, a cationic surfactant, an anionic surfactant, and an amphoteric surfactant can be used. The surfactant may be a silicone-based surfactant. These may be used alone, or may be used in a combination of two or more kinds thereof.

Examples of the nonionic surfactant include polyoxyethylene octyl ether, polyoxyethylene decyl ether, polyoxyethylene lauryl ether, polyoxyethylene laurylamine, polyoxyethylene oleylamine, polyoxyethylene polystyryl phenyl ether, polyoxyalkylene polystyryl phenyl ether, polyoxyalkylene primary alkyl ether, and polyoxyalkylene secondary alkyl ether. Examples of the cationic surfactant include oleylamine acetate, laurylpyridinium chloride, cetylpyridinium chloride, lauryltrimethylammonium chloride, stearyltrimethylammonium chloride, behenyltrimethylammonium chloride, didecyldimethylammonium chloride, and didecyldimethylammonium bromide. Examples of the anionic surfactant include coconut fatty acid salts, castor sulfated oil salts, lauryl sulfate salts, polyoxyalkylene allyl phenyl ether sulfate salts, alkyl benzene sulfonic acids, alkyl benzene sulfonates, alkyl diphenyl ether disulfonates, alkyl naphthalene sulfonates, dialkyl sulfosuccinates, isopropyl phosphates, polyoxyethylene alkyl ether phosphates, polyoxyethylene allyl phenyl ether phosphates, and dialkyl sulfosuccinates. Examples of the amphoteric surfactant include coconut alkyl dimethylamine oxide, fatty acid amidopropyl dimethylamine oxide, alkyl polyaminoethyl glycine hydrochloride, an amido betaine-type surfactant, an alanine-type surfactant, and lauryl iminodipropionic acid.

A content of the surfactant (C) is preferably 0.1 parts by mass or more and 20 parts by mass or less, more preferably 0.5 parts by mass or more and 15 parts by mass or less, and still more preferably 1 part by mass or more and 10 parts by mass or less with respect to 100 parts by mass of the substrate component (B). Within the above numerical range, good antifogging properties and anti-fog durability are easily obtained.

### [Initiator (D)]

When the anti-fog coating composition contains the polymerizable monomer (B2), the anti-fog coating composition preferably contains the initiator (D). The initiator (D) is not particularly limited, and a conventionally known photopolymerization initiator, a thermal polymerization initiator, and the like can be used, but a photopolymerization initiator is preferable from the viewpoint of easily curing the anti-fog coating composition well in a short time.

Specific examples of the photopolymerization initiator include 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one, 1-(4-isopropylphenyl)-2-hydroxy-2-methylpropan-1-one, 1-(4-dodecylphenyl)-2-hydroxy-2-methylpropan-1-one, 2,2-dimethoxy-1,2-diphenylethan-1-one, bis(4-dimethylaminophenyl)ketone, 2-methyl-1-[4-(methylthio)phenyl]-2-morpholinopropan-1-one, 2-benzyl-2-dimethylamino-1-(4-morpholinophenyl)-butan-1-one, 1,2-octanedione, 1-[4-(phenylthio)phenyl]-, 2-(0-benzoyloxime) (Irgacure OXE01), ethanone-1-[9-ethyl-6-(2-methylbenzoyl)-9H-carbazol-3-yl]-1-(0-acetyloxime) (Irgacure OXE02), 2,4,6-trimethylbenzoyldiphenylphosphine oxide (Omnirad TPO H), bis(2,4,6-trimethylbenzoyl)phenylphosphine oxide (Omnirad 819), 4-benzoyl-4′-methyldimethylsulfide, 4-dimethylaminobenzoic acid, methyl 4-dimethylaminobenzoate, ethyl 4-dimethylaminobenzoate, butyl 4-dimethylaminobenzoate, 4-dimethylamino-2-ethylhexylbenzoic acid, 4-dimethylamino-2-isoamylbenzoic acid, benzyl-β-methoxyethyl acetal, benzyl dimethyl ketal, 1-phenyl-1,2-propanedione-2-(0-ethoxycarbonyl) oxime, methyl 0-benzoylbenzoate, 2,4-diethylthioxanthone, 2-chlorothioxanthone, 2,4-dimethylthioxanthone, 1-chloro-4-propoxythioxanthone, thioxanthene, 2-chlorothioxanthene, 2,4-diethylthioxanthene, 2-methylthioxanthene, 2-isopropylthioxanthene, 2-ethylanthraquinone, octamethylanthraquinone, 1,2-benzanthraquinone, 2,3-diphenylanthraquinone, azobisisobutyronitrile, benzoyl peroxide, cumene hydroperoxide, 2-mercaptobenzoimidazole, 2-mercaptobenzoxazole, 2-mercaptobenzothiazole, 2-(0-chlorophenyl)-4,5-di(m-methoxyphenyl)-imidazolyl dimer, benzophenone, 2-chlorobenzophenone, p,p′-bis(dimethylamino)benzophenone, 4,4′-bisdiethylaminobenzophenone, 4,4′-dichlorobenzophenone, 3,3-dimethyl-4-methoxybenzophenone, benzyl, benzoin, benzoin methyl ether, benzoin ethyl ether, benzoin isopropyl ether, benzoin-n-butyl ether, benzoin isobutyl ether, benzoin butyl ether, acetophenone, 2,2-diethoxyacetophenone, p-dimethylacetophenone, p-dimethylaminopropiophenone, dichloroacetophenone, trichloroacetophenone, p-tert-butylacetophenone, p-dimethylaminoacetophenone, p-tert-butyltrichloroacetophenone, p-tert-butyldichloroacetophenone, α,α-dichloro-4-phenoxyacetophenone, thioxanthone, 2-methylthioxanthone, 2-isopropylthioxanthone, dibenzosuberone, pentyl-4-dimethylaminobenzoate, 9-phenylacridine, 1,7-bis-(9-acridinyl)heptane, 1,5-bis-(9-acridinyl)pentane, 1,3-bis-(9-acridinyl)propane, p-methoxytriazine, 2,4,6-tris(trichloromethyl)-s-triazine, 2-methyl-4,6-bis(trichloromethyl)-s-triazine, 2-[2-(5-methylfuran-2-yl)ethenyl]-4,6-bis(trichloromethyl)-s-triazine, 2-[2-(furan-2-yl)ethenyl]-4,6-bis(trichloromethyl)-s-triazine, 2-[2-(4-diethylamino-2-methylphenyl)ethenyl]-4,6-bis(trichloromethyl)-s-triazine, 2-[2-(3,4-dimethoxyphenyl)ethenyl]-4,6-bis(trichloromethyl)-s-triazine, 2-(4-methoxyphenyl)-4,6-bis(trichloromethyl)-s-triazine, 2-(4-ethoxystyryl)-4,6-bis(trichloromethyl)-s-triazine, 2-(4-n-butoxyphenyl)-4,6-bis(trichloromethyl)-s-triazine, 2,4-bis-trichloromethyl-6-(3-bromo-4-methoxy)phenyl-s-triazine, 2,4-bis-trichloromethyl-6-(2-bromo-4-methoxy)phenyl-s-triazine, 2,4-bis-trichloromethyl-6-(3-bromo-4-methoxy)styrylphenyl-s-triazine, and 2,4-bis-trichloromethyl-6-(2-bromo-4-methoxy)styrylphenyl-s-triazine. These photopolymerization initiators can be used alone or in a combination of two or more kinds thereof.

Specific examples of the thermal polymerization initiator include organic peroxides such as a ketone peroxide (methyl ethyl ketone peroxide, cyclohexanone peroxide, and the like), peroxyketal (2,2-bis(tert-butylperoxy)butane, 1,1-bis(tert-butylperoxy)cyclohexane, or the like), hydroperoxide (tert-butyl hydroperoxide, cumene hydroperoxide, and the like), a dialkyl peroxide (di-tert-butyl peroxide (Perbutyl (registered trademark) D (manufactured by NOF Corporation)), di-tert-hexyl peroxide (Perhexyl (registered trademark) D (manufactured by NOF Corporation)), and the like), a diacyl peroxide (isobutyryl peroxide, lauroyl peroxide, benzoyl peroxide, and the like), peroxydicarbonate (diisopropyl peroxydicarbonate, and the like), and peroxyester (tert-butyl peroxyisobutyrate, 2,5-dimethyl-2,5-di(benzoylperoxy)hexane, and the like), and azo compounds such as 1,1′-azobis(cyclohexane-1-carbonitrile), 2,2′-azobisisobutyronitrile, 2,2′-azobis(2,4-dimethyl-4-methoxyvaleronitrile), 2,2′-azobis(2-methylpropionamidine) dihydrochloride, 2,2′-azobis[2-methyl-N-(2-propenyl) propionamidine]dihydrochloride, 2,2′-azobis(2-methylpropionamide), 2,2′-azobis[2-methyl-N-(2-hydroxyethyl) propionamide], 2,2′-azobis(2-methylpropane), 2,2′-azobis(2,4,4-trimethylpentane), and dimethyl 2,2′-azobis(2-methylpropionate). These thermal polymerization initiators can be used alone or in a combination of two or more kinds thereof.

A content of the initiator (D) per 100 parts by mass of the substrate component (B) is preferably 0.1 parts by mass or more and 20 parts by mass or less, more preferably 1 part by mass or more and 15 parts by mass or less, and still more preferably 3 parts by mass or more and 12 parts by mass or less. Within the above numerical range, good antifogging properties and anti-fog durability are easily obtained.

### [Solvent (E)]

The anti-fog coating composition preferably contains a solvent (E) for the purpose of adjusting coatability, viscosity, and the like. The type of the solvent (E) is not particularly limited, but is typically an organic solvent. The type of the organic solvent is not particularly limited as long as the components contained in the anti-fog coating composition can be uniformly dissolved or dispersed.

Examples of the organic solvent include (poly)alkylene glycol monoalkyl ethers such as ethylene glycol monomethyl ether, ethylene glycol monoethyl ether, ethylene glycol-n-propyl ether, ethylene glycol mono-n-butyl ether, diethylene glycol monomethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether, propylene glycol mono-n-propyl ether, propylene glycol mono-n-butyl ether, dipropylene glycol monomethyl ether, dipropylene glycol monoethyl ether, dipropylene glycol mono-n-propyl ether, dipropylene glycol mono-n-butyl ether, tripropylene glycol monomethyl ether, and tripropylene glycol monoethyl ether; (poly)alkylene glycol monoalkyl ether acetates such as ethylene glycol monomethyl ether acetate, ethylene glycol monoethyl ether acetate, diethylene glycol monomethyl ether acetate, diethylene glycol monoethyl ether acetate, propylene glycol monomethyl ether acetate, and propylene glycol monoethyl ether acetate; other ethers such as diethylene glycol dimethyl ether, diethylene glycol methyl ethyl ether, diethylene glycol diethyl ether, and tetrahydrofuran; ketones such as methyl ethyl ketone, cyclohexanone, 2-heptanone, and 3-heptanone; alkyl lactate esters such as methyl 2-hydroxypropionate and ethyl 2-hydroxypropionate; other esters such as ethyl 2-hydroxy-2-methylpropionate, methyl 3-methoxypropionate, ethyl 3-methoxypropionate, methyl 3-ethoxypropionate, ethyl 3-ethoxypropionate, ethyl ethoxyacetate, ethyl hydroxyacetate, methyl 2-hydroxy-3-methylbutanoate, 3-methoxybutyl acetate, 3-methyl-3-methoxybutyl acetate, 3-methyl-3-methoxybutyl propionate, ethyl acetate, n-propyl acetate, isopropyl acetate, n-butyl acetate, isobutyl acetate, n-pentyl formate, isopentyl acetate, n-butyl propionate, ethyl butyrate, n-propyl butyrate, isopropyl butyrate, n-butyl butyrate, methyl pyruvate, ethyl pyruvate, n-propyl pyruvate, methyl acetoacetate, ethyl acetoacetate, and ethyl 2-oxobutanoate; aromatic hydrocarbons such as toluene and xylene; amides such as N-methylpyrrolidone, N,N-dimethylformamide, and N,N-dimethylacetamide; and alcohols such as ethanol, isopropyl alcohol, and butanol. These may be used alone, or may be used in a combination of two or more kinds thereof.

A content of the solvent (E) is not particularly limited. From the viewpoint of film forming properties, when the mass of the anti-fog coating composition excluding the mass of the solvent (E) is defined as the solid content, the solvent is used such that a solid content concentration is preferably 0.1 mass % or more and 99 mass % or less, and more preferably 1 mass % or more and 50 mass % or less.

### [Other Components]

In addition to the components described above, the anti-fog coating composition may contain various additives conventionally blended in an anti-fog coating composition. Preferable examples of the additive include a dispersant, an adhesion promoter such as a silane coupling agent, an antioxidant, an aggregation inhibitor, and an antifoaming agent.

### <Anti-Fog Coating Film>

The anti-fog coating film is obtained by drying and/or curing a coating film formed from the anti-fog coating composition, that is, the anti-fog coating film is a dried product and/or a cured product of the coating film formed from the anti-fog coating composition.

A method for forming the coating film formed from the anti-fog coating composition is not particularly limited. For example, a coating film can be formed by applying the anti-fog coating composition to a surface of a transparent material of an optical product so as to have a desired film thickness using a contact transfer type coating device such as a roll coater, a reverse coater, a bar coater, and a slit coater, and a non-contact coating device such as a spinner (rotary coating device) and a curtain flow coater. The coating film can also be formed by various printing methods such as dip coating, inkjet printing, and gravure printing.

A method for drying the coating film is not particularly limited, and conventionally known methods such as natural drying and heat drying can be adopted.

A method for curing the coating film is not particularly limited, and an anti-fog coating film as a cured product can be obtained by exposing the coating film when the anti-fog coating composition is photocurable, and heating the coating film when the composition is thermosetting. The conditions for exposing the coating film are not particularly limited as long as the curing proceeds satisfactorily. The exposure is performed by irradiation with active energy rays such as ultraviolet rays or excimer laser light. An irradiation energy dose is not particularly limited, and is, for example, 30 mJ/cm² or more and 5,000 mJ/cm² or less.

The anti-fog coating film is disposed on the surface of the transparent material of the optical product. The anti-fog coating film may be disposed on a part of the surface of the transparent material, or may be disposed on the entire surface.

The transparent material is not particularly limited, and examples thereof include transparent plastics and glass (including glass constituting a front surface of a mirror). The transparent material may be completely transparent or translucent.

The optical product is not particularly limited as long as a product includes a transparent material that interferes with a normal view by a user when fogged, and interferes with normal transmission, reflection, and the like of a light beam in an optical instrument when fogged. Specific examples of the optical product include mirrors such as a vehicle rearview mirror, a bathroom mirror, a lavatory mirror, a dental mirror, and a road mirror; windows of a building, a monitoring tower, an automobile, a railway vehicle, an aircraft, a ship, a submersible vessel, a snowmobile, a ropeway gondola, an amusement park gondola, and a spacecraft; a prism; lenses such as a spectacle lens, an optical lens, a photographic lens, an endoscope lens, an illumination lens, a semiconductor lens, and a copying machine lens; and goggles such as protection goggles and sports goggles.

As described above, the present inventor provides the following aspects (1) to (10).
(1) An optical product including: a transparent material; and an anti-fog coating film disposed on a surface of the transparent material,
the anti-fog coating film being obtained by drying and/or curing a coating film formed from an anti-fog coating composition,
the anti-fog coating composition containing a polymer (A), a substrate component (B), and a surfactant (C),
the polymer (A) containing a constituent unit derived from a compound (a), a constituent unit derived from a compound (b), and a constituent unit derived from a compound (c),
the polymer (A) having a structure derived from a compound (d) at least at one terminal of a main chain,
the compound (a) being a compound containing an ethylenically unsaturated group and an ionic group,
the compound (b) being a compound containing an ethylenically unsaturated group and an —OH group and/or an —NH₂ group,
the compound (c) being a compound represented by the following formula (c-1),
the compound (d) being a compound comprising a thiol group and a hydrocarbon group having 4 or more carbon atoms,
the substrate component (B) containing a resin (B1) and/or a polymerizable monomer (B2),

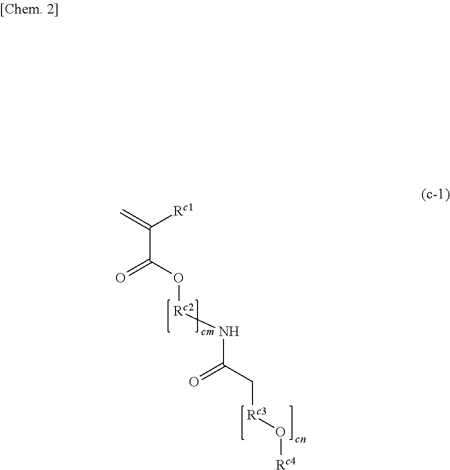

wherein R^{c1} represents a hydrogen atom or a methyl group, R^{c2} represents a divalent hydrocarbon group having 1 or more and 12 or less carbon atoms, R^{c3} represents a divalent hydrocarbon group having 2 or more and 4 or less carbon atoms, R^{c4} represents a monovalent hydrocarbon group having 12 or more carbon atoms, cm represents 0 or 1, and cn represents an integer of 1 or more and 500 or less.
(2) The optical product according to (1), which is a mirror, a window, a prism, a lens, or a goggle.
(3) An anti-fog coating composition containing: a polymer (A); a substrate component (B); and a surfactant (C),
the polymer (A) containing a constituent unit derived from a compound (a), a constituent unit derived from a compound (b), and a constituent unit derived from a compound (c),
the polymer (A) having a structure derived from a compound (d) at least at one terminal of a main chain,
the compound (a) being a compound containing an ethylenically unsaturated group and an ionic group,
the compound (b) being a compound containing an ethylenically unsaturated group and an —OH group and/or an —NH₂ group, the compound (c) being a compound represented by the following formula (c-1),
the compound (d) being a compound containing a thiol group and a hydrocarbon group having 4 or more carbon atoms,
the substrate component (B) containing a resin (B1) and/or a polymerizable monomer (B2),

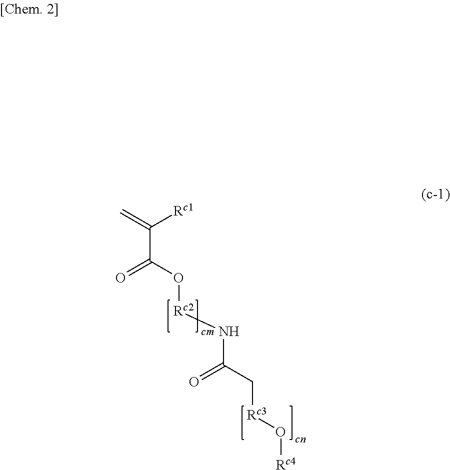

wherein R^{c1} represents a hydrogen atom or a methyl group, R^{c2} represents a hydrocarbon group having 1 or more and 12 or less carbon atoms, R^{c3} represents a hydrocarbon group having 2 or more and 4 or less carbon atoms, R^{c4} represents a hydrocarbon group having 12 or more carbon atoms, cm represents 0 or 1, and cn represents an integer of 1 or more and 500 or less.
(4) The anti-fog coating composition according to (3), wherein with respect to all constituent units of the polymer (A),
a molar ratio of the constituent unit derived from the compound (a) is 50 mol % or more and 98 mol % or less,
a molar ratio of the constituent unit derived from the compound (b) is 1 mol % or more and 40 mol % or less, and
a molar ratio of the constituent unit derived from the compound (c) is 1 mol % or more and 20 mol % or less.
(5) The anti-fog coating composition according to (3) or (4), in which a mass of the polymer (A) is 0.05 parts by mass or more and 10 parts by mass or less with respect to 100 parts by mass of the substrate component (B).
(6) The anti-fog coating composition according to any one of (3) to (5), in which the substrate component (B) contains the polymerizable monomer (B2).
(7) A cured product of the anti-fog coating composition according to any one of (3) to (6).
(8) An anti-fog coating film obtained by drying and/or curing a coating film formed from the anti-fog coating composition according to any one of (3) to (6).
(9) A polymer containing: a constituent unit derived from a compound (a); a constituent unit derived from a compound (b); and a constituent unit derived from a compound (c),
the polymer having a structure derived from a compound (d) at least at one terminal of a main chain,
the compound (a) being a compound containing an ethylenically unsaturated group and an ionic group,
the compound (b) being a compound containing an ethylenically unsaturated group and an —OH group and/or an —NH₂ group,
the compound (c) being a compound represented by the following formula (c-1),
the compound (d) being a compound comprising a thiol group and a hydrocarbon group having 4 or more carbon atoms,

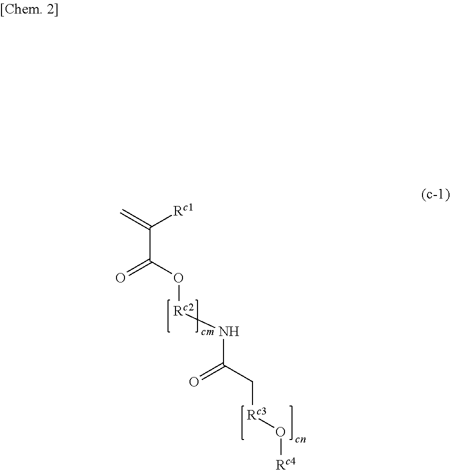

wherein R^{c1} represents a hydrogen atom or a methyl group, R^{c2} represents a hydrocarbon group having 1 or more and 12 or less carbon atoms, R^{c3} represents a hydrocarbon group having 2 or more and 4 or less carbon atoms, R^{c4} represents a hydrocarbon group having 12 or more carbon atoms, cm represents 0 or 1, and cn represents an integer of 1 or more and 500 or less.
(10) A method for producing the polymer according to (9), the method including: polymerizing the compound (a), the compound (b), and the compound (c) in the presence of the compound (d).

### Examples

The present invention will be described in more detail based on Examples, but the present invention is not limited to these Examples.

The chemicals used in synthesis of a polymer are listed below.

Compound a1: a compound represented by the following formula

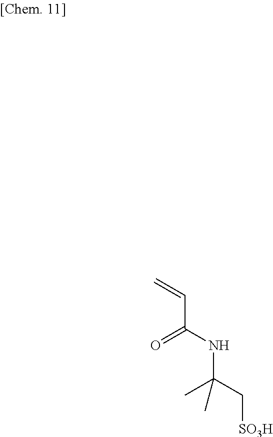

Compound a2: a compound represented by the following formula

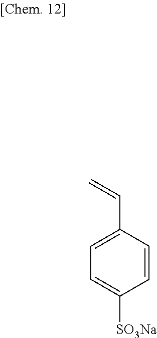

Compound b1: acrylic acid

Compound b2: acrylamide

Compound c1: a compound represented by the following formula and synthesized by a method to be described below. A double bond contained in an alkenyl group having 18 carbon atoms in the following formula is a cis double bond.

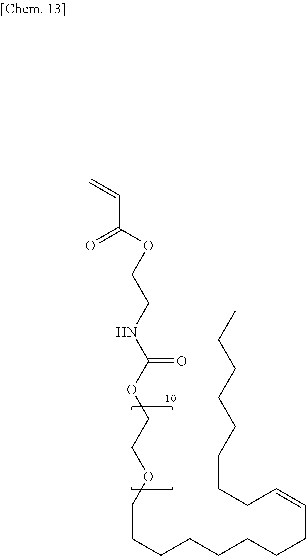

Compound d1: 1-dodecanethiol
   <Synthesis of Compound c1>

In a 50 mL glass container, 25.12 g (about 35 mmol) of polyethylene glycol monooleyl ether (HO(CH₂CH₂O)ₙC₁₈H₃₅ (n=about 10, manufactured by Tokyo Chemical Industry Co., Ltd.) and 5 g of 2-acryloyloxyethyl isocyanate (Karenz AOI manufactured by Resonac Corporation) were mixed. The mixed solution was stirred at 60° C. for 3 hours to obtain a compound c1.

### <Synthesis of Polymer>

[Polymer (a-1)]

In a 50 mL glass container, 12.5 g (about 12.1 mmol) of a 20 mass % aqueous solution of the compound a1 as the compound (a), 6.87 g (about 1.9 mmol) of a 2 mass % aqueous solution of the compound b1 as the compound (b), 0.54 g (about 0.6 mmol) of the compound c1 as the compound (c), 0.26 g of a 1 mass % propylene glycol monomethyl ether solution of the compound d1 as the compound (d), and 0.02 g of an azo polymerization initiator (VA-061 manufactured by Tokyo Chemical Industry Co., Ltd.) were added, and water was added such that a solid content concentration was 10 mass %. After nitrogen substitution, the mixed solution was heated to 80° C. while stirring and reacted for 4 hours at 80° C. while stirring to obtain an approximately 10 mass % aqueous solution of the polymer (a-1). The polymer (a-1) had a weight average molecular weight of 651,700 and a dispersity of 52. A repeating structure and a terminal end structure of the polymer (a-1) are shown below. The numerical value at the lower right of [ ] is a molar ratio of each constituent unit to all constituent units.

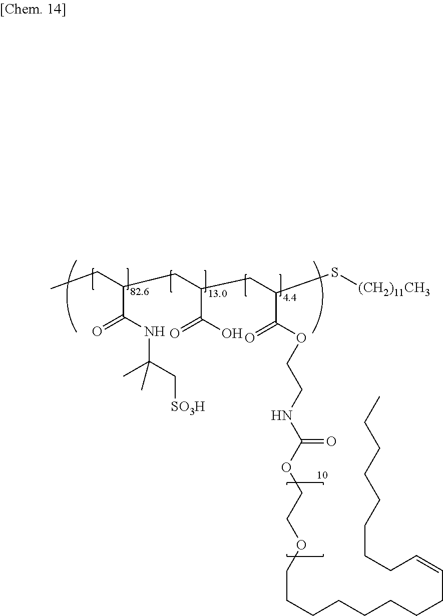

[Polymer (a-2)]

A polymer (a-2) was synthesized in the same manner as the polymer (a-1) except that the compound a2 was used as the compound (a) instead of the compound a1, the amount of each compound was changed, and water was added such that the solid content concentration was 5 mass %. The polymer (a-2) had a weight average molecular weight of 78,600 and a dispersity of 29.8. A repeating structure and a terminal end structure of the polymer (a-2) are shown below. The numerical value at the lower right of [ ] is a molar ratio of each constituent unit to all constituent units.

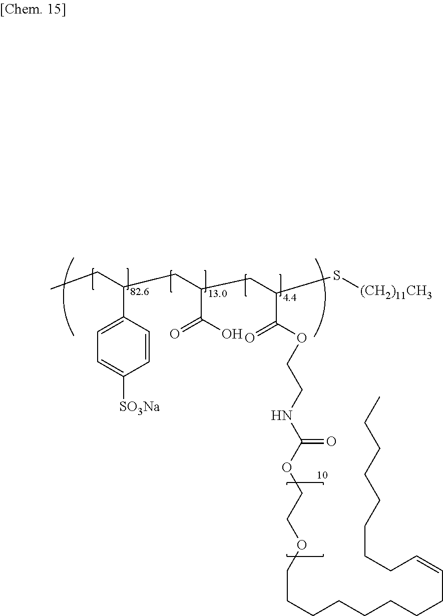

[Polymer (a-3)]

A polymer (a-3) was synthesized in the same manner as the polymer (a-1) except that the compound a2 was used as the compound (a) instead of the compound a1 and the amount of each compound was changed. The polymer (a-3) had a weight average molecular weight of 122,800 and a dispersity of 19.1. A repeating structure and a terminal end structure of the polymer (a-3) are shown below. The numerical value at the lower right of [ ] is a molar ratio of each constituent unit to all constituent units.

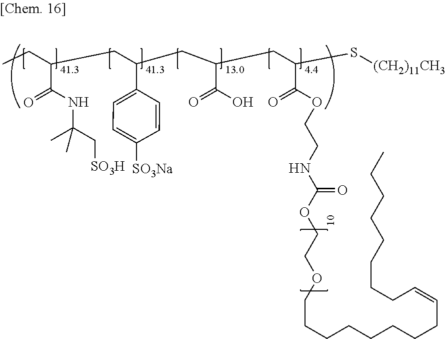

[Polymer (a-4) to Polymer (a-8)]

Polymers (a-4) to (a-8) were synthesized in the same manner as the polymer (a-1) except that the amount of each compound was changed. The polymer (a-4) had a weight average molecular weight of 776,700 and a dispersity of 65.8, the polymer (a-5) had a weight average molecular weight of 560,100 and a dispersity of 41.8, the polymer (a-6) had a weight average molecular weight of 700,700 and a dispersity of 44.1, the polymer (a-7) had a weight average molecular weight of 941,300 and a dispersity of 55.5, and the polymer (a-8) had a weight average molecular weight of 1,022,700 and a dispersity of 73.5.

[Polymer (a-9)]

A polymer (a-9) was synthesized in the same manner as the polymer (a-1) except that the compound b2 was used as the compound (b) instead of the compound b1 and the amount of each compound was changed. The polymer (a-9) had a weight average molecular weight of 563,400 and a dispersity of 39.2. A repeating structure and a terminal end structure of the polymer (a-9) are shown below. The numerical value at the lower right of [ ] is a molar ratio of each constituent unit to all constituent units.

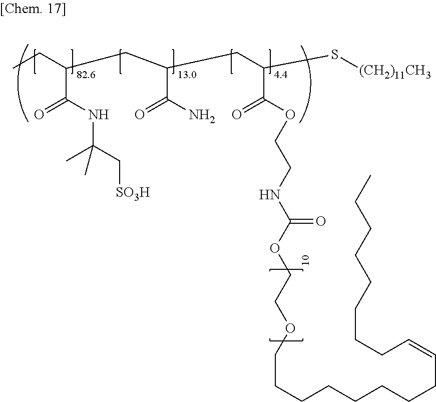

[Polymer (a-10)]

A polymer (a-10) was synthesized in the same manner as the polymer (a-1) except that the compound (a) was not added and the amount of each compound was changed. The polymer (a-10) had a weight average molecular weight of 402,000 and a dispersity of 33.1. A repeating structure and a terminal end structure of the polymer (a-10) are shown below. The numerical value at the lower right of [ ] is a molar ratio of each constituent unit to all constituent units.

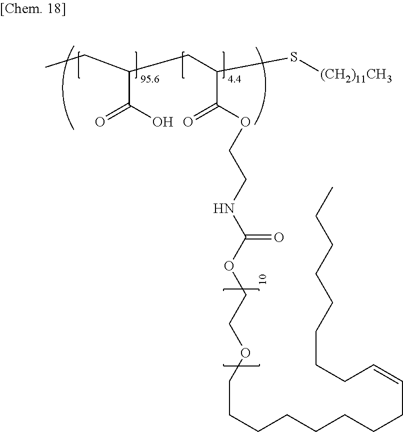

[Polymer (a-11)]

A polymer (a-11) was synthesized in the same manner as the polymer (a-1) except that the compound (b) was not added and the amount of each compound was changed. The polymer (a-11) had a weight average molecular weight of 385,400 and a dispersity of 34.7. A repeating structure and a terminal end structure of the polymer (a-11) are shown below. The numerical value at the lower right of [ ] is a molar ratio of each constituent unit to all constituent units.

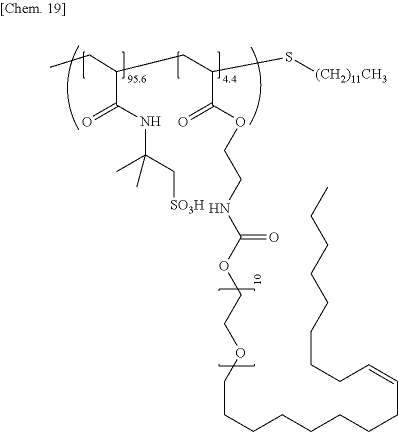

[Polymer (a-12)]

A polymer (a-12) was synthesized in the same manner as the polymer (a-1) except that the compound (c) was not added and the amount of each compound was changed. The polymer (a-12) had a weight average molecular weight of 423,000 and a dispersity of 40.1. A repeating structure and a terminal end structure of the polymer (a-12) are shown below. The numerical value at the lower right of [ ] is a molar ratio of each constituent unit to all constituent units.

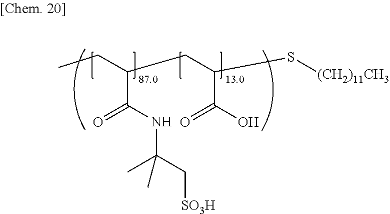

[Polymer (a-13)]

A polymer (a-13) was synthesized in the same manner as the polymer (a-1) except that 1 mass % of a propylene glycol monomethyl ether solution of the compound d1 was not added. The polymer (a-13) had a weight average molecular weight of 986,000 and a dispersity of 51.8. A repeating structure and a terminal end structure of the polymer (a-13) are shown below. The numerical value at the lower right of [ ] is a molar ratio of each constituent unit to all constituent units.

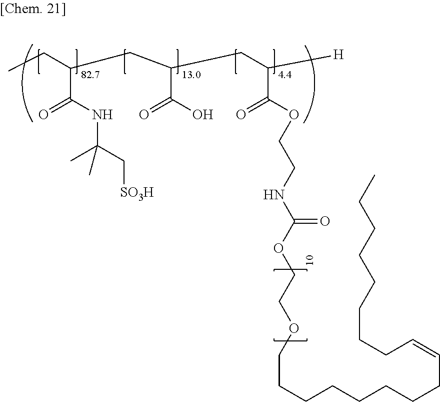

The molar ratio of each constituent unit to all constituent units of the polymers (a-1) to (a-14) is shown in Table 1. The presence or absence of the structure (d) in the polymers (a-1) to (a-14) is shown in Table 1.

The chemicals used in Examples and Comparative Examples are listed below.
a-1 to a-14: Polymers (a-1) to (a-14) synthesized by the above methods
b-1: an acrylate compound represented by the following formula (total of m: 60, n: 4, HLB value: 16.11)

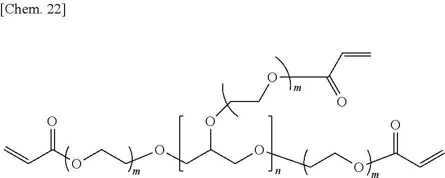

b-2: KAYARAD DPHA (manufactured by Nippon Kayaku Co., Ltd., a mixture of dipentaerythritol hexaacrylate (a=6, b=0)/dipentaerythritol pentaacrylate (a=5, b=1) represented by the following formula, HLB value: 0.65 or less)

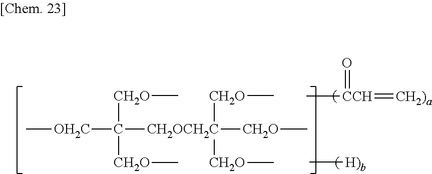

c-1: sodium di-2-ethylhexyl sulfosuccinate (manufactured by Tokyo Chemical Industry Co., Ltd., anionic surfactant, a compound represented by the following formula)

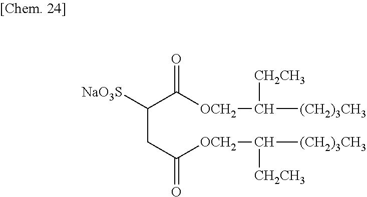

d-1: IRGACURE 651 (manufactured by IGM Resins, a compound represented by the following formula (Ph represents a phenyl group))

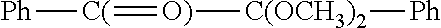

e-1: propylene glycol monomethyl ether (PGME)
e-2: isopropyl alcohol (IPA)

### Examples and Comparative Examples

Polymers of the types and amounts (parts by mass) listed in Table 1, 70 parts by mass of the compound b-1, 30 parts by mass of the compound b-2, 1 part by mass of the compound c-1, 5 parts by mass of the compound d-1, 112 parts by mass of the compound e-1, and 4 parts by mass of the compound e-2 were uniformly mixed to obtain anti-fog coating compositions of Examples and Comparative Examples. Each of the obtained anti-fog coating compositions was applied to a 5 cm×5 cm polycarbonate (PC) plate using a spin coater, and the coating film was heated at 80° C. for 1 minute. Thereafter, exposure was performed at an irradiation dose of 1000 mJ/cm² using an ultra-high pressure mercury lamp to produce a PC plate (anti-fog PC plate) including an anti-fog coating film having a film thickness of 5 μm.

### <Anti-Fog Durability>

The anti-fog PC plate was immersed in 1 L of pure water in a vat for 2 hours. Thereafter, the anti-fog PC plate was taken out and dried at room temperature for 18 hours. To a 1000 mL beaker, 700 mL of 50° C. water was added, and the anti-fog coating film of the dried anti-fog PC plate was exposed at a position of 7 cm from the water surface for 3 minutes. A fogging state of the anti-fog PC plate at that time was visually evaluated according to the following criteria. The results are shown in Table 1.
A: No fogging
B: Fogging

In Table 1, (a) to (d) represent the compounds (a) to (d), respectively. The presence or absence of the structure (d) derived from the compound (d) in the polymer is shown in the column (d).

TABLE 1

| | | Polymer | | | | | | | | | |
|---|---|---|---|---|---|---|---|---|---|---|---|
| | | | (a) | | (b) | | (c) | | | | |
| | | | | mol | | mol | | mol | | | Anti-fog |
| | | Type | Type | ratio | Type | ratio | Type | ratio | (d) | Amount | durability |
| Example | 1 | a-1 | a1 | 82.6 | b1 | 13.0 | c1 | 4.4 | Present | 0.5 | A |
| | 2 | a-2 | a2 | 82.6 | b1 | 13.0 | c1 | 4.4 | Present | 0.5 | A |
| | 3 | a-3 | a1 | 41.3 | b1 | 13.0 | c1 | 4.4 | Present | 0.5 | A |
| | | | a2 | 41.3 | | | | | | | |
| | 4 | a-4 | a1 | 90.4 | b1 | 4.8 | c1 | 4.8 | Present | 0.5 | A |
| | 5 | a-5 | a1 | 86.4 | b1 | 9.1 | c1 | 4.5 | Present | 0.5 | A |
| | 6 | a-6 | a1 | 79.1 | b1 | 16.7 | c1 | 4.2 | Present | 0.5 | A |
| | 7 | a-7 | a1 | 75.9 | b1 | 20.0 | c1 | 4.1 | Present | 0.5 | A |
| | 8 | a-8 | a1 | 73.1 | b1 | 23.1 | c1 | 3.8 | Present | 0.5 | A |
| | 9 | a-9 | a1 | 82.6 | b2 | 13.0 | c1 | 4.4 | Present | 0.5 | A |
| | 10 | a-1 | a1 | 82.6 | b1 | 13.0 | c1 | 4.4 | Present | 1 | A |
| Comparative | 1 | — | — | — | — | — | — | — | — | 0 | B |
| example | 2 | a-10 | — | — | b1 | 95.6 | c1 | 4.4 | Present | 0.5 | B |
| | 3 | a-11 | a1 | 95.6 | — | — | c1 | 4.4 | Present | 0.5 | B |
| | 4 | a-12 | a1 | 87.0 | b1 | 13.0 | — | — | Present | 0.5 | B |
| | 5 | a-13 | a1 | 82.7 | b1 | 13.0 | c1 | 4.3 | Absent | 0.5 | B |

As shown in Table 1, the anti-tog durability of Examples in which the predetermined polymer (A) was added was good, whereas the anti-fog durability of Comparative Example 1 in which the predetermined polymer (A) was not added and Comparative Examples 2 to 5 in which a polymer other than the predetermined polymer (A) was added was poor. Therefore, it was confirmed that the anti-fog coating composition according to the present invention provides an anti-fog coating film excellent in anti-fog durability.

What is claimed is:

1. An optical product comprising: a transparent material; and an anti-fog coating film disposed on a surface of the transparent material,
the anti-fog coating film being obtained by drying and/or curing a coating film formed from an anti-fog coating composition,
the anti-fog coating composition comprising a polymer (A), a substrate component (B), and a surfactant (C),
the polymer (A) comprising a constituent unit derived from a compound (a), a constituent unit derived from a compound (b), and a constituent unit derived from a compound (c),
the polymer (A) having a structure derived from a compound (d) at least at one terminal of a main chain,
the compound (a) being a compound comprising an ethylenically unsaturated group and an ionic group,
the compound (b) being a compound comprising an ethylenically unsaturated group and an —OH group and/or an —NH₂ group,
the compound (c) being a compound represented by the following formula (c-1),
the compound (d) being a compound comprising a thiol group and a hydrocarbon group having 4 or more carbon atoms,
the substrate component (B) comprising a resin (B1) and/or a polymerizable monomer (B2), 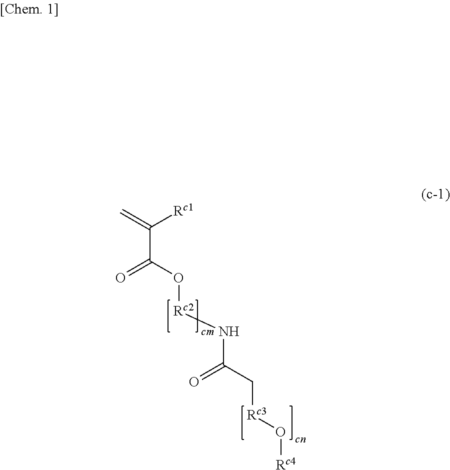
wherein R^{c1} represents a hydrogen atom or a methyl group, R^{c2} represents a hydrocarbon group having 1 or more and 12 or less carbon atoms, R^{c3} represents a hydrocarbon group having 2 or more and 4 or less carbon atoms, R^{c4} represents a hydrocarbon group having 12 or more carbon atoms, cm represents 0 or 1, and cn represents an integer of 1 or more and 500 or less.

2. The optical product according to claim 1, which is a mirror, a window, a prism, a lens, or a goggle.

3. An anti-fog coating composition comprising: a polymer (A); a substrate component (B); and a surfactant (C),
the polymer (A) comprising a constituent unit derived from a compound (a), a constituent unit derived from a compound (b), and a constituent unit derived from a compound (c),
the polymer (A) having a structure derived from a compound (d) at least at one terminal of a main chain,
the compound (a) being a compound comprising an ethylenically unsaturated group and an ionic group,
the compound (b) being a compound comprising an ethylenically unsaturated group and an —OH group and/or an —NH₂ group,
the compound (c) being a compound represented by the following formula (c-1),
the compound (d) being a compound comprising a thiol group and a hydrocarbon group having 4 or more carbon atoms,
the substrate component (B) comprising a resin (B1) and/or a polymerizable monomer (B2), 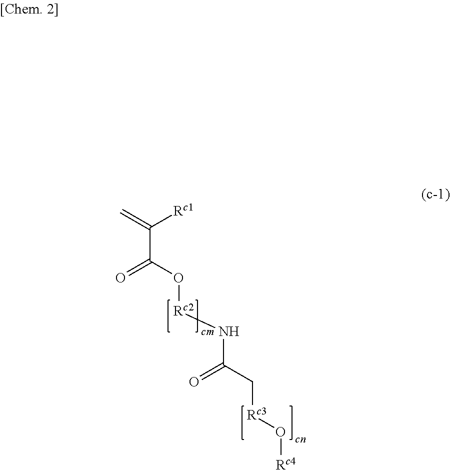
wherein R^{c1} represents a hydrogen atom or a methyl group, R^{c2} represents a hydrocarbon group having 1 or more and 12 or less carbon atoms, R^{c3} represents a hydrocarbon group having 2 or more and 4 or less carbon atoms, R^{c4} represents a hydrocarbon group having 12 or more carbon atoms, cm represents 0 or 1, and cn represents an integer of 1 or more and 500 or less.

4. The anti-fog coating composition according to claim 3, wherein with respect to all constituent units of the polymer (A),
a molar ratio of the constituent unit derived from the compound (a) is 50 mol % or more and 98 mol % or less,
a molar ratio of the constituent unit derived from the compound (b) is 1 mol % or more and 40 mol % or less, and
a molar ratio of the constituent unit derived from the compound (c) is 1 mol % or more and 20 mol % or less.

5. The anti-fog coating composition according to claim 3, wherein a mass of the polymer (A) is 0.05 parts by mass or more and 10 parts by mass or less with respect to 100 parts by mass of the substrate component (B).

6. The anti-fog coating composition according to claim 3, wherein the substrate component (B) comprises the polymerizable monomer (B2).

7. A cured product of the anti-fog coating composition according to claim 6.

8. An anti-fog coating film obtained by drying and/or curing a coating film formed from the anti-fog coating composition according to claim 3.

9. A polymer comprising: a constituent unit derived from a compound (a); a constituent unit derived from a compound (b); and a constituent unit derived from a compound (c),
the polymer having a structure derived from a compound (d) at least at one terminal of a main chain,
the compound (a) being a compound comprising an ethylenically unsaturated group and an ionic group,
the compound (b) being a compound comprising an ethylenically unsaturated group and an —OH group and/or an —NH₂ group,
the compound (c) being a compound represented by the following formula (c-1),
the compound (d) being a compound comprising a thiol group and a hydrocarbon group having 4 or more carbon atoms, 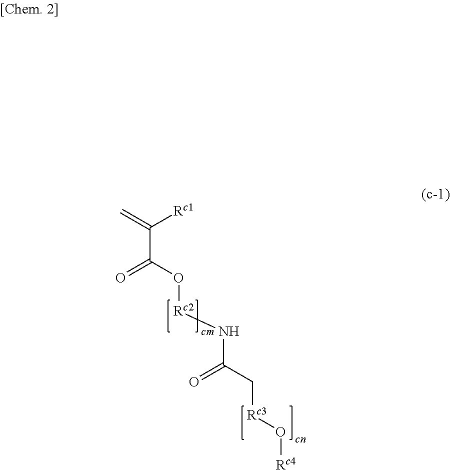
wherein R^{c1} represents a hydrogen atom or a methyl group, R^{c2} represents a hydrocarbon group having 1 or more and 12 or less carbon atoms, R^{c3} represents a hydrocarbon group having 2 or more and 4 or less carbon atoms, R^{c4} represents a hydrocarbon group having 12 or more carbon atoms, cm represents 0 or 1, and cn represents an integer of 1 or more and 500 or less.

10. A method for producing the polymer according to claim 9, the method comprising: polymerizing the compound (a), the compound (b), and the compound (c) in the presence of the compound (d).
